(19) United States
(12) Patent Application Publication
(10) Pub. No.: US 2018/0206380 A1
(43) Pub. Date: Jul. 26, 2018

(54) GRADER MOLDBOARD STRUCTURE

(71) Applicant: ZHEJIANG PACIFIC MACHINERY CO., LTD, Deqing (CN)

(72) Inventor: Zhijian ZHOU, Deqing (CN)

(73) Assignee: ZHEJIANG PACIFIC MACHINERY CO., LTD, Deqing (CN)

(21) Appl. No.: 15/653,552

(22) Filed: Jul. 19, 2017

(30) Foreign Application Priority Data
Jan. 25, 2017 (CN) 201710056534.X
Jan. 25, 2017 (CN) 201720097290.5

(51) Int. Cl. A01B 15/10; A01B 13/02

(52) U.S. Cl. CPC A01B 15/10; A01B 13/025

(57) ABSTRACT

A grader moldboard structure, comprising a left moldboard, a plurality of middle moldboard having the same structure, and a right moldboard that are sequentially connected to form a long stripe-like moldboard body; wherein two sides of the middle moldboard are each provided with a non-strike-through transverse half-waist circular groove and a semi-circular hole in the groove, connection edges of one sides of the left moldboard and the right moldboard are each provided with a non-strike-through transverse half-waist circular groove and a semi-circular hole in the groove, the two half-waist circular grooves being spliced to form a waist circular groove for inserting a connection block, a positioning circular hole corresponding to a circular hole formed in the middle of the waist circular groove being provided in the middle of the connection block.

### CROSS REFERENCE TO RELATED APPLICATIONS

The present application claims priority to Chinese Patent Application CN 201710056534.X filed on Jan. 25, 2017 and to Chinese Patent Application CN 201720097290.5 filed on Jan. 25, 2017.

### TECHNICAL FIELD

The present invention relates to a grader moldboard structure, pertaining to the technical field of grader moldboards.

### BACKGROUND

Motor graders are used to grade a base material such as gravel or sand to provide a generally planar or contoured surface. It can be used to provide a consistent grade to a surface such as a road bed or road shoulder. These operations are accomplished by the accurate positioning and control of a moldboard which is suspended beneath the grader frame. The moldboard is slidable relative to a drawbar used to secure the moldboard to the grader frame.

The conventional graders, especially grader moldboards, employ an integral moldboard structure, and thus have a large width. Therefore, the integral moldboard structure has a low strength and is easy to be damaged. Particularly, this moldboard structure is inconvenient to transport, assemble and disassemble, and has a short lifetime.

### SUMMARY

An objective of the present invention is provide a grader moldboard structure improved based on the prior art to address the defect in the prior art.

The objective of the present invention is achieved by the following technical solution: a grader moldboard structure, comprising a left moldboard, a plurality of middle moldboard having the same structure, and a right moldboard that are sequentially connected to form a long stripe-like moldboard body; wherein two sides of the middle moldboard are each provided with a non-strike-through transverse half-waist circular groove and a semi-circular hole in the groove, connection edges of one sides of the left moldboard and the right moldboard are each provided with a non-strike-through transverse half-waist circular groove and a semi-circular hole in the groove, the two half-waist circular grooves being spliced to form a waist circular groove for inserting a connection block, a positioning circular hole corresponding to a circular hole formed in the middle of the waist circular groove being provided in the middle of the connection block; at least one row of upper hard alloy blocks sequentially connected to each other are welded on front upper edges of the left moldboard, the middle moldboards and the right moldboard respectively, at least inner and outer rows of particulate hard alloy layers being at least parallelly welded on an inner upper surface of the upper hard alloy blocks, lateral particulate hard alloy layers perpendicular to the two rows of particulate hard alloy layers along a lateral side being welded on both ends of the two rows of particulate hard alloy layers.

Preferably, the left moldboard and the right moldboard are each provided with two parallelly-arranged positioning holes, and a middle positioning hole is arranged at a middle position on the middle moldboard; the connection block is embedded into the waist circular groove, an upper surface thereof being not higher than the upper surface of the moldboard, the periphery of the waist circular groove being provided with an inner-tapered beveled edge for ease of placement and positioning of the connection block, and correspondingly a periphery of the connection block being provided with an inner-tapered beveled edge; a row of sequentially-connected middle hard alloy blocks are embedded and welded to end-face middle portions of the front edges of the left moldboard, the middle moldboards and the right moldboard below the upper hard alloy blocks, and the middle hard alloy blocks and the upper hard alloy blocks are parallelly arranged.

Preferably, the upper hard alloy blocks and the middle hard alloy blocks are respectively embedded on the end faces of the front edges of the left moldboard, the middle moldboards and the right moldboard to form an integrity, and the inner and outer rows of particulate hard alloy layers are respectively embedded on the front upper surfaces of the left moldboard, the middle moldboards and the right moldboard and form an integrity with the moldboard bodies; the lateral particulate hard alloy layers are respectively embedded on the lateral upper surfaces of the left moldboard and the right moldboard and form an integrity with the moldboard bodies; and a rectangular groove is at least arranged on a back of each of the left moldboard, the middle moldboards and the right moldboard.

The present invention makes some improvements to the prior art. The grader moldboard structure according to the present invention is reasonable, is convenient to use and convenient to transport, assemble and disassemble, improves the use efficiency, enhances the integral abrasion-resistance, and prolongs the lifetime.

### BRIEF DESCRIPTION OF THE DRAWINGS

FIG. 1 is a schematic front view of a grader moldboard structure according to the present invention;

FIG. 2 is a schematic front view of the grader moldboard structure according to the present invention;

FIG. 3 is a schematic side view of a grader moldboard structure according to the present invention; and

FIG. 4 is a schematic back view of the grader moldboard structure according to the present invention.

### DETAILED DESCRIPTION

The present invention is described in detail hereinafter with reference to the accompanying drawings.

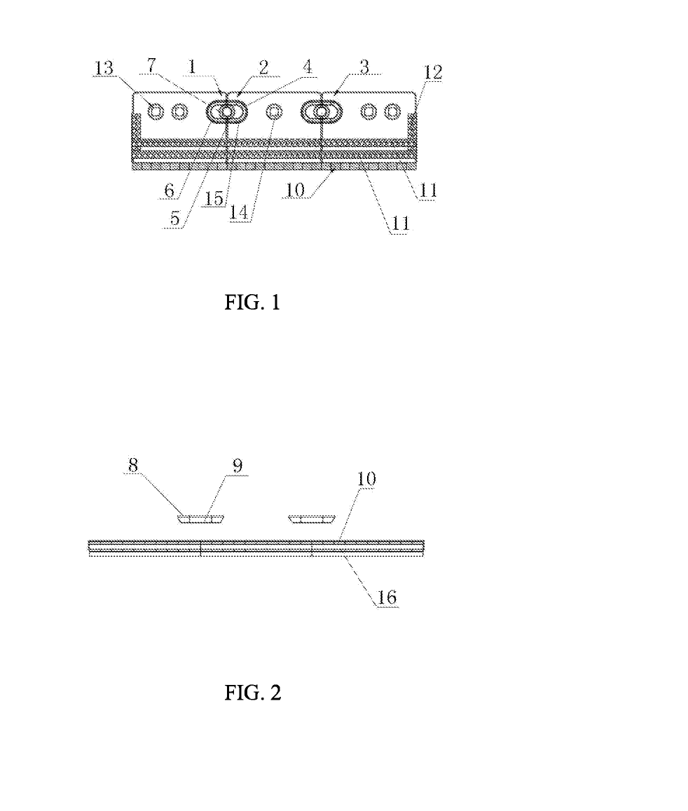

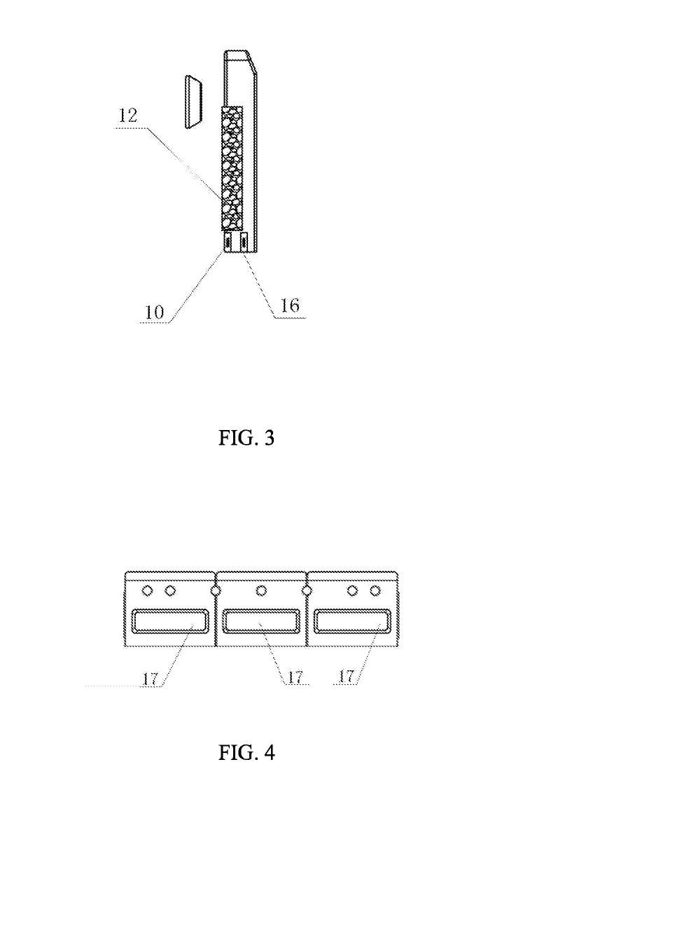

As illustrated in FIG. 1 to FIG. 4, the present invention provides a grader moldboard structure, comprising a left moldboard 1, a plurality of middle moldboards 2 having the same structure, and a right moldboard that are sequentially connected to form a long stripe-like. As illustrated in FIG. 1 to FIG. 4, only one middle moldboard 2 is provided for ease of description of the structure. It should be noted that embodiments of the present invention comprise 2 to 30 middle moldboards 2, and the embodiment comprising 22 middle moldboards is a preferred embodiment.

As illustrated in the drawings, two sides of the middle moldboard 2 are each provided with a non-strike-through transverse half-waist circular groove 4 and a semi-circular hole 5 in the groove, and connection edges of one sides of the left moldboard 1 and the right moldboard 3 are each provided with a non-strike-through transverse half-waist circular groove 6 and a semi-circular hole 7 in the groove. The two half-waist circular grooves 4 and 6 are spliced to form a waist circular groove for inserting a connection block 8. A positioning circular hole 9 corresponding to a circular hole formed in the middle of the waist circular groove is provided in the middle of the connection block 8.

At least one row of upper hard alloy blocks 10 sequentially connected to each other are welded on front upper edges of the left moldboard 1, the middle moldboards 2 and the right moldboard 3 respectively, at least inner and outer rows of particulate hard alloy layers 11 are at least parallelly welded on an inner upper surface of the upper hard alloy blocks 10, and lateral particulate hard alloy layers 12 perpendicular to the two rows of particulate hard alloy layers 11 along a lateral side are welded on both ends of the two rows of particulate hard alloy layers 11.

As illustrated in the drawings, the left moldboard 1 and the right moldboard 3 are each provided with two parallelly-arranged positioning holes 13, and a middle positioning hole 14 is arranged at a middle position on the middle moldboard 2; the connection block 8 is embedded into the waist circular groove, an upper surface thereof being not higher than the upper surface of the moldboard. The periphery of the waist circular groove is provided with an inner-tapered beveled edge 15 for ease of placement and positioning of the connection block, and correspondingly a periphery of the connection block 8 are provided with an inner-tapered beveled edge.

A row of sequentially-connected middle hard alloy blocks 16 are embedded and welded to end-face middle portions of the front edges of the left moldboard 1, the middle moldboards 2 and the right moldboard 3 below the upper hard alloy blocks, and the middle hard alloy blocks 16 and the upper hard alloy blocks 10 are parallelly arranged. The upper hard alloy blocks 10 and the middle hard alloy blocks 16 are respectively embedded on the end faces of the front edges of the left moldboard 1, the middle moldboards 2 and the right moldboard 3 to form an integral body, and the inner and outer rows of particulate hard alloy layers 11 are respectively embedded on the front upper surfaces of the left moldboard 1, the middle moldboards 2 and the right moldboard 3 and form an integral body with the moldboard bodies. The lateral particulate hard alloy layers 12 are respectively embedded on the lateral upper surfaces of the left moldboard 1 and the right moldboard 3 and form an integral body with the moldboard bodies.

As illustrated in FIG. 4, a rectangular groove 17 is at least arranged on a back of each of the left moldboard, the middle moldboards and the right moldboard.

According to the present invention, the left moldboard 1, the middle moldboards 2 and the right moldboard 3 are spliced to form an integral moldboard body. Owing to a combination of a plurality of block structures, the moldboard structure in the present invention is convenient to transport and disassemble. The special design of the particulate hard alloy layer and double hard alloy block layers greatly improves the abrasion-resistance of the product, and prolongs the lifetime of the product by 2 to 3 times. The elliptical connection block is mounted on the moldboard body (a block-shaped body) via a threaded bolt, which achieves good securing and locking effects.

What is claimed is:

1. A grader moldboard structure, comprising a left moldboard, a plurality of middle moldboard having the same structure, and a right moldboard that are sequentially connected to form a long strip-like moldboard body; wherein two sides of the middle moldboard are each provided with a non-strike-through transverse half-waist circular groove and a semi-circular hole in the groove, connection edges of one sides of the left moldboard and the right moldboard are each provided with a non-strike-through transverse half-waist circular groove and a semi-circular hole in the groove, the two half-waist circular grooves being spliced to form a waist circular groove for inserting a connection block, a positioning circular hole corresponding to a circular hole formed in the middle of the waist circular groove being provided in the middle of the connection block; at least one row of hard alloy blocks sequentially connected to each other is welded on front upper edges of the left moldboard, the middle moldboards and the right moldboard respectively, at least inner and outer two rows of particulate hard alloy layers being at least parallelly welded on an inner upper surface of the hard alloy block, a lateral particulate hard alloy layer perpendicular to the two rows of particulate hard alloy layers along a lateral side being welded on both ends of the two rows of particulate hard alloy layers.

2. The grader moldboard structure according to claim 1, wherein the left moldboard and the right moldboard are each provided with two parallelly-arranged positioning holes, and a middle positioning hole is arranged at a middle position on the middle moldboard; the connection block is embedded into the waist circular groove, an upper surface thereof being not higher than the upper surface of the moldboard, the periphery of the waist circular groove being provided with an inner-tapered beveled edge for ease of placement and positioning of the connection block, and correspondingly a periphery of the connection block being provided with an inner-tapered beveled edge; a row of sequentially-connected middle hard alloy blocks are embedded and welded to end-face middle portions of the front edges of the left moldboard, the middle moldboards and the right moldboard below the upper hard alloy blocks, and the middle hard alloy blocks and the upper hard alloy blocks are parallelly arranged.

3. The grader moldboard structure according to claim 2, wherein the upper hard alloy blocks and the middle hard alloy blocks are respectively embedded on the end faces of the front edges of the left moldboard, the middle moldboards and the right moldboard to form an integrity, and the inner and outer rows of particulate hard alloy layers are respectively embedded on the front upper surfaces of the left moldboard, the middle moldboards and the right moldboard and form an integrity with the moldboard bodies; the lateral particulate hard alloy layers are respectively embedded on the lateral upper surfaces of the left moldboard and the right moldboard and form an integrity with the moldboard bodies; and a rectangular groove is at least arranged on a back of each of the left moldboard, the middle moldboards and the right moldboard.
